(19) United States
(12) Patent Application Publication
(10) Pub. No.: US 2021/0357835 A1
(43) Pub. Date: Nov. 18, 2021

(54) Resource Deployment Predictions Using Machine Learning

(71) Applicant: Oracle International Corporation, Redwood Shores, CA (US)

(72) Inventors: Suresh Babu MODI, Dublin, CA (US); Karthik KOTHANDARAMAN, Fremont, CA (US); Kleber L. SALES, San Ramon, CA (US)

(21) Appl. No.: 15/931,252

(22) Filed: May 13, 2020

(51) Int. Cl. G06Q 10/06; G06F 16/26; G06Q 10/10; G06Q 30/00; G06N 20/20; G06N 5/04; G06F 40/40

(52) U.S. Cl. CPC G06Q 10/06315; G06F 16/26; G06Q 10/105; G06F 40/40; G06N 20/20; G06N 5/04; G06Q 30/018

(57) ABSTRACT

Embodiments are generally directed to systems and methods for generating resource deployment predictions using an ensemble machine learning model. An ensemble machine learning model trained or configured by an aggregated data set can be provided, where the aggregated data set includes data about resources deployed in enterprise deployment scenarios aggregated from a plurality of enterprise sources. Data about a first resource can be received including natural language data and numeric score data. A matching score between the first resource and a first enterprise deployment scenario can be determined based on a matching between natural language data descriptive of the first resource and natural language data descriptive of the first enterprise deployment scenario. Resource deployment parameters can be predicted using the ensemble machine learning model based on the determined matching score and the received numeric score data about the first resource.

### FIELD

The embodiments of the present disclosure generally relate to generating resource deployment predictions using an ensemble machine learning model.

### BACKGROUND

In order to be effective, enterprises are expected to leverage available resources to efficiently generate value. However, resources have become increasingly specialized, heterogenous, and complex. In addition, enterprises themselves can be complex organization, at times operating in numerous sectors and deploying resources in varying conditions. As a result, the challenge of successfully finding and deploying resources has grown. Accordingly, effectively utilizing data related to resource deployment can improve enterprise efficiency.

### SUMMARY

The embodiments of the present disclosure are generally directed to systems and methods for generating resource deployment predictions using an ensemble machine learning model. An ensemble machine learning model trained or configured by an aggregated data set can be provided, where the aggregated data set includes data about resources deployed in enterprise deployment scenarios aggregated from a plurality of enterprise sources. Data about a first resource can be received including natural language data and numeric score data. A matching score between the first resource and a first enterprise deployment scenario can be determined based on a matching between natural language data descriptive of the first resource and natural language data descriptive of the first enterprise deployment scenario. Resource deployment parameters can be predicted using the ensemble machine learning model based on the determined matching score and the received numeric score data about the first resource

Features and advantages of the embodiments are set forth in the description which follows, or will be apparent from the description, or may be learned by practice of the disclosure.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a system for generating resource deployment predictions using an ensemble machine learning model according to an example embodiment.

FIG. 2 illustrates a block diagram of a computing device operatively coupled to a system according to an example embodiment.

FIG. 3 illustrates a prediction system according to an example embodiment.

FIG. 4 illustrates a diagram for implementing an ensemble machine learning model according to an example embodiment.

FIG. 5 illustrates a user interface for visualizing predictions for resource deployment according to an example embodiment.

FIG. 6 illustrates a relation among vectors according to an example embodiment.

FIG. 7 illustrates a flow diagram for an enterprise job requisition according to an example embodiment.

FIG. 8 illustrates a flow diagram for generating resource deployment predictions using an ensemble machine learning model according to an example embodiment.

FIG. 9 illustrates a flow diagram for generating resource deployment predictions using an ensemble machine learning model and a broadened data set according to an example embodiment.

### DETAILED DESCRIPTION

Embodiments generate resource deployment predictions using an ensemble machine learning model. For example, enterprises can deploy a mix of resources in a variety of circumstances, such as software as a service (“SaaS”) tools, people resources, physical tools (e.g., vehicles, robotic equipment, and training equipment), and the like. With the rise of resource types, specializations, and complexity, predictions about resource deployment that rely on enterprise and resource data sets can increase the likelihood of success when deploying a new resource or re-deploying an existing resource.

Embodiments provide an ensemble machine learning model trained or configured by an aggregated data set to predict deployment parameters for a candidate enterprise resource. For example, the aggregated data set can include data about resources deployed in enterprise deployment scenarios (e.g., historic data) aggregated from a variety of enterprise sources (e.g., across a number of divisions, departments, or business units). In some embodiments, the aggregated data can be based on natural language data and numeric data. For example, a job profile and/or an employee/candidate profile can include natural language descriptions. In another example, an employee's or candidate's evaluation can include numeric score data (e.g., from 1-5). These different data formats can be processed and aggregated into a data set for machine learning.

Embodiments can also receive data about a resource that is a candidate for deployment. For example, the data about the candidate for deployment can also include natural language data and numeric data. In some implementations, the resource can be a candidate or employee for a certain job position at the enterprise. The received data about the candidate can include a natural language profile that is descriptive of the candidate and numeric scores (e.g., interview scores) about the candidate.

Embodiments can determine a match score between the candidate resource and the enterprise deployment scenario. For example, a description of a job can be compared to a job candidate's qualifications. In another example, a description of software requirements can be compared to a description of a SaaS tool. Other suitable data can be used to match the candidate resource with the deployment scenario.

In some embodiments, parameters for the resource deployment can be predicted using the trained or configured ensemble machine learning model based on the determined match score and numeric score about the candidate resource. For example, parameters can be predicted for a job offer for the candidate resource, such as compensation and other suitable job parameters. In another example, parameters for how a SaaS tool can be used with existing systems can be generated. Embodiments predict resource deployment parameters using the ensemble machine learning model with a likelihood of success, thus reducing the effort required to deploy enterprise resources.

In some embodiments, filtered data can be retrieved from various enterprise sources based on the enterprise deployment scenario. For example, the enterprise deployment scenario can be a job position at the enterprise, and filters related to the job position can be used to retrieve the filtered data set. In some instances, enterprise data for a given division, department, and/or business unit can be subject to access restrictions due to confidentiality requirements. For example, confidentiality can be required by regulation (e.g., for human resources) or part of an enterprise policy (e.g., for sensitive business data). Embodiments selectively filter data from these different data sources such that confidentiality requirements are not compromised.

In some embodiments, a distribution can be calculated based on the filtered data set. For example, the calculated distribution can provide informative context for the enterprise deployment scenario (e.g., job position at the enterprise). In some embodiments, the distribution can be displayed along with the predicted parameters (e.g., parameters for a job offer, such as compensation). Embodiments display this information to a user, thus providing a deployment scenario with a predicted likelihood of success while also providing context based on current and/or historic deployment scenarios (e.g., for similar resources).

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

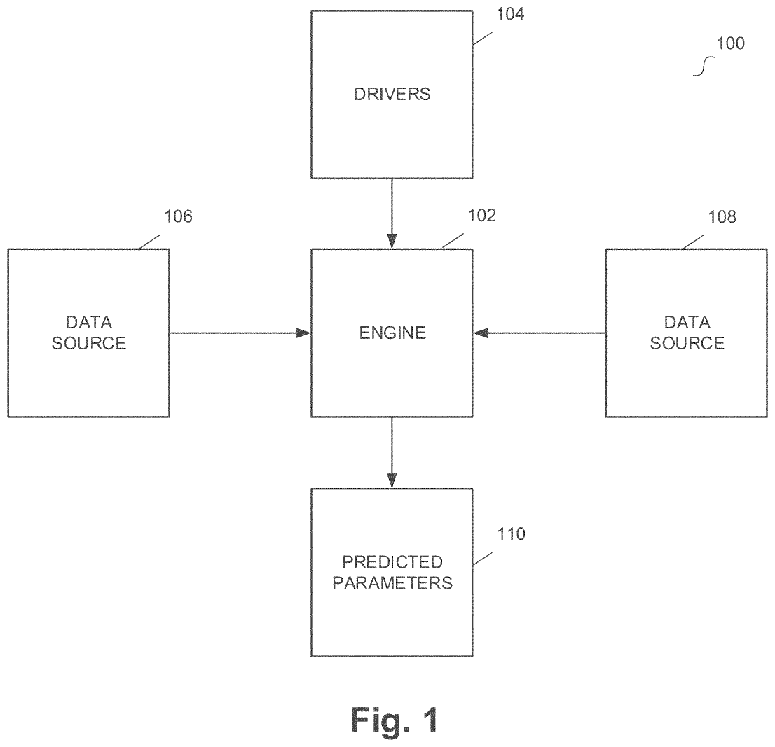

FIG. 1 illustrates a system for generating resource deployment predictions using an ensemble machine learning model according to an example embodiment. System 100 includes engine 102, drivers 104, data sources 106 and 108, and predicted parameters 110. Engine 102 can retrieve or aggregate data from data sources 106 and 108, such as data related to enterprise resources. In some embodiments, engine 102 can include a machine learning model configured to generate predicted parameters 110 for deployment of a candidate resource in a specific enterprise deployment scenario. Drivers 104 can serve as inputs for engine 104 that configure the predictions or data processing. For example, the specific enterprise deployment scenario can be a specific employee position at an enterprise (e.g., data scientist, business development professional, sales lead, and the like), data sources 106 and 108 can be different sources that store data related to the specific enterprise deployment scenario, and engine 102 can use aggregated data from data sets 106 and 108 as well as input from drivers 104 to generate predicted deployment parameters (predicted parameters 110) for a new or transfer employee in the specific employee position. In some embodiments, the predicted deployment parameters can be displayed along with a filtered data set that provides context related to the enterprise deployment scenario. Resources other than an employee, such as a SaaS tool, can similarly be implemented.

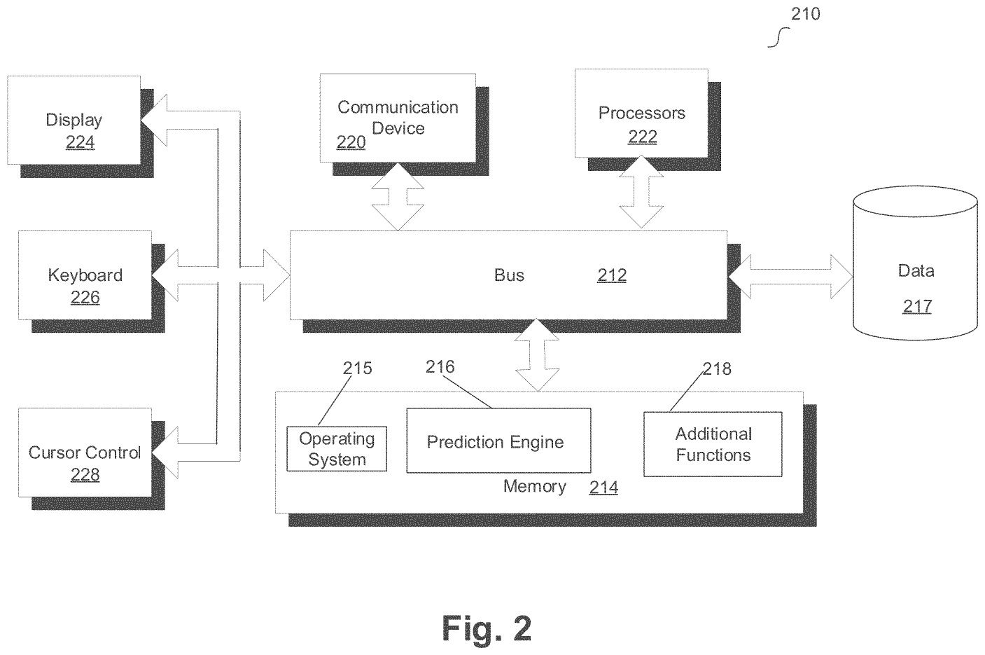

FIG. 2 is a block diagram of a computer server/system 210 in accordance with embodiments. All or portions of system 210 may be used to implement any of the elements shown in FIG. 1. As shown in FIG. 2, system 210 may include a bus device 212 and/or other communication mechanism(s) configured to communicate information between the various components of system 210, such as processor 222 and memory 214. In addition, communication device 220 may enable connectivity between processor 222 and other devices by encoding data to be sent from processor 222 to another device over a network (not shown) and decoding data received from another system over the network for processor 222.

For example, communication device 220 may include a network interface card that is configured to provide wireless network communications. A variety of wireless communication techniques may be used including infrared, radio, Bluetooth®, Wi-Fi, and/or cellular communications. Alternatively, communication device 220 may be configured to provide wired network connection(s), such as an Ethernet connection.

Processor 222 may include one or more general or specific purpose processors to perform computation and control functions of system 210. Processor 222 may include a single integrated circuit, such as a micro-processing device, or may include multiple integrated circuit devices and/or circuit boards working in cooperation to accomplish the functions of processor 222. In addition, processor 222 may execute computer programs, such as operating system 215, prediction engine 216, and other applications 218, stored within memory 214.

System 210 may include memory 214 for storing information and instructions for execution by processor 222. Memory 214 may contain various components for retrieving, presenting, modifying, and storing data. For example, memory 214 may store software modules that provide functionality when executed by processor 222. The modules may include an operating system 215 that provides operating system functionality for system 210. The modules can include an operating system 215, prediction engine 216 configured to predict resource deployment parameters, as well as other applications modules 218. Operating system 215 provides operating system functionality for system 210. In some instances, prediction engine 216 may be implemented as an in-memory configuration. When system 210 executes the functionality of prediction engine 216, it implements as a non-conventional specialized computer system that performs the functionality disclosed herein.

Non-transitory memory 214 may include a variety of computer-readable medium that may be accessed by processor 222. For example, memory 214 may include any combination of random access memory (“RAM”), dynamic RAM (“DRAM”), static RAM (“SRAM”), read only memory (“ROM”), flash memory, cache memory, and/or any other type of non-transitory computer-readable medium.

Processor 222 is further coupled via bus 212 to a display 224, such as a Liquid Crystal Display (“LCD”). A keyboard 226 and a cursor control device 228, such as a computer mouse, are further coupled to communication device 212 to enable a user to interface with system 210.

In some embodiments, system 210 can be part of a larger system. Therefore, system 210 can include one or more additional functional modules 218 to include the additional functionality. Other applications modules 218 may include the various modules of Oracle® Cloud Service (“OCS”), Oracle® Recruiting Cloud (“ORC”), and Oracle® Fusion Human Capital Management Cloud, for example. A database 217 is coupled to bus 212 to provide centralized storage for modules 216 and 218 and to store, for example, data received from various devices. Database 217 can store data in an integrated collection of logically-related records or files. Database 217 can be an operational database, an analytical database, a data warehouse, a distributed database, an end-user database, an external database, a navigational database, an in-memory database, a document-oriented database, a real-time database, a relational database, an object-oriented database, a non-relational database, a NoSQL database, Hadoop® distributed file system (“HFDS”), or any other database known in the art.

Although shown as a single system, the functionality of system 210 may be implemented as a distributed system. For example, memory 214 and processor 222 may be distributed across multiple different computers that collectively represent system 200. In one embodiment, system 210 may be part of a device (e.g., smartphone, tablet, computer, etc.). In an embodiment, system 210 may be separate from the device, and may remotely provide the disclosed functionality for the device. Further, one or more component of system 210 may not be included. For example, for functionality as a user or consumer device, system 210 may be a smartphone or other wireless device that includes a processor, memory, and a display, does not include one or more of the other components shown in FIG. 2, and includes additional components not shown in FIG. 2, such as an antenna, transceiver, or any other suitable wireless device component.

Embodiments predict resource deployment parameters based on an aggregated data set about enterprise resources. For example, a data set about employees at an enterprise can be aggregated and used to predict resource deployment parameters for a new hire or a transfer. In some embodiments, the data set can be specific to a one or more resource types, such as specific enterprise positions (e.g., data scientist, business development professional, software developer, sales lead, and the like), or generic to enterprise employees, include data about multiple people that occupy the position(s) (at the enterprise), and further include additional aspects of data about these people (e.g., position grade, grade salary, location, bonus structure, other compensation, performance and evaluation scores, and the like). Referring back to FIG. 2, prediction engine 216 can include a machine learning model that, using the data set, can generate predicted parameters configured to result in successful resource deployment. Other resources, such as a SaaS tool, can be similarly implemented.

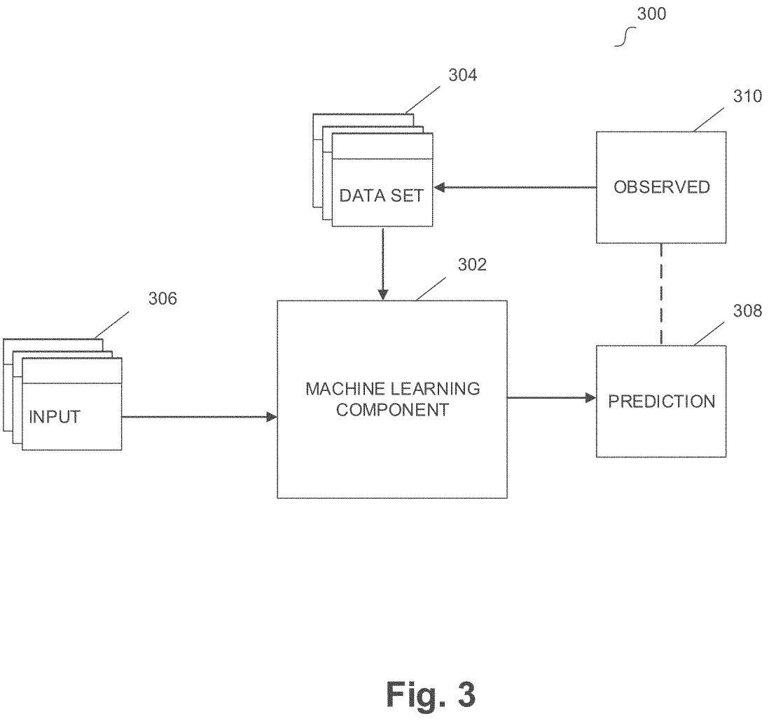

FIG. 3 illustrates a prediction system according to an example embodiment. System 300 includes machine learning component 302, data set 304, input data 306, prediction 308, and observed data 310. In some embodiments, machine learning component 302 can be a designed model that includes one or more machine learning elements (e.g., a neural network, support vector machine, Bayesian network, random forest classifier, gradient boosting classifier, regression or specialized regression model, and the like). Data set 304 can be any set of data capable of configuring machine learning component 302 to generate predictions, such as training data (e.g., a set of features with corresponding labels, such as labeled data for supervised learning), an aggregated set of related data points (e.g., a data set for unsupervised learning), and the like. In some embodiments, data set 304 can be used to train machine learning component 302 to generate a trained machine learning model. In some embodiments, machine learning component 302 can be a pre-trained machine learning model that can be further configured for deployment in a specific setting.

In some embodiments, data set 304 can include data about enterprise resources. For example, resources at an enterprise can be employees with varying job positions (e.g. data scientist, business development professional, software developer, sales lead, and the like), that include a variety of additional information (e.g. job location, job grade, business unit, and the like) and data set 304 can include data about people in these positions (e.g., in various enterprise deployment scenarios). In an example, data set 304 can be specific to an enterprise position (e.g., software developer), include data about multiple people that occupy the position (e.g., across the enterprise, across one or more business units of the enterprise, or across any other suitable division or section of the enterprise), and further include additional aspects of data about these people (e.g., position grade, grade salary, location, location, bonus structure, other compensation, performance and evaluation scores, and the like).

In another example, data set 304 can be specific to a set of enterprise positions (e.g., software developer, software engineer, data scientist, or other positions related to software or computer science) or include a wide variety of enterprise positions (e.g. data scientist, business development professional, software developer, sales lead, and the like), include data about multiple people that occupy the positions (e.g., across the enterprise, across one or more business units of the enterprise, or across any other suitable division or section of the enterprise), and further include additional aspects of data about these people (e.g., position grade, grade salary, location, location, bonus structure, other compensation, performance and evaluation scores, and the like). Machine learning component 302 can be configured to generate prediction 308 based on data set 304 (and other information) that includes predicted resource deployment parameters for a candidate resource in an enterprise deployment scenario (e.g., specific enterprise job position).

Accordingly, prediction 308 generated by machine learning component 302 trained or configured by embodiments of data set 304 can be predicted deployment parameters for a candidate resource in an enterprise deployment scenario. For example, where the candidate resource is a job candidate, the deployment parameters can include job offer parameters (e.g., offer value, compensation, job location, and the like). In some embodiments, machine learning component 302 is trained/configured by data set 304 to predict deployment parameters that meet a probability of success. In an example, success can be represented by acceptance of a job offer extended to a candidate resource. In some embodiments, data set 304 can include historic data related to a candidate resource, resource quality (e.g., based on a composite score, as further disclosed herein), deployment parameters in an offer (e.g., offer compensation values), and acceptance or rejection of the offer by the candidate resource. Data set 304 can also include resource deployment scenarios (e.g., job positions at the enterprise) for this historic data. Accordingly, data set 304 can train/configure learning component 302 to predict deployment parameters for an offer to a candidate resource and confidence values for the predictions.

In some embodiments, the predicted resource deployment parameters (or a portion of the predicted parameters) can be used to deploy the candidate resource. Upon implementing the deployment parameters (e.g., extending the job offer), the effectiveness of the predicted parameters can be determined, such as the success rate of the resource deployment (e.g., rate of acceptance of the job offer, success of the employee once the job offer is accepted, and the like). Feedback about the predicted resource deployment parameters can be retrieved (e.g., represented in FIG. 3 as observed data 310), and this feedback can be processed to update data set 304.

The design of machine learning component 302 can include any suitable machine learning model components (e.g., a neural network, support vector machine, specialized regression model, random forest classifier, gradient boosting classifier, and the like). For example, a neural network can be implemented along with a given cost function (e.g., for training/gradient calculation). The neural network can include any number of hidden layers (e.g., 0, 1, 2, 3, or many more), and can include feed forward neural networks, recurrent neural networks, convolution neural networks, modular neural networks, and any other suitable type. In some embodiments, the neural network can be configured for deep learning, for example based on the number of hidden layers implemented. In some examples, a Bayesian network can be similarly implemented, or other types of supervised learning models.

A support vector machine can be implemented, in some instances along with one or more kernels (e.g., gaussian kernel, linear kernel, and the like). In some embodiments, a k-nearest neighbor (“KNN”) algorithm can be implemented. For example, a KNN algorithm can determine a distance between a candidate resource (e.g., represented by input 306) and the instances of data set 304, and one or more “nearest neighbors” relative to this distance can be determined (the number of neighbors can be based on a value selected for K). Prediction 308 can then be generated based on the distances from these “nearest neighbor” instances.

In some embodiments, machine learning component 302 can be an ensemble learning model. For example, machine learning component 302 can include a random forest classifier that includes multiple machine learning components whose predictions are combined. Implementations of the random forest classifier include decision trees that are trained by data set 304 (e.g., using subsets of the training data per tree). The random forest algorithm can then aggregate votes from these decision trees to arrive at a prediction.

In some embodiments, machine learning model 302 can include a gradient boosting learning algorithm, such as XGBoost. The gradient boosting algorithm can similarly leverage an ensemble learning technique with multiple decision trees trained using data set 304, however the gradient boosting algorithm can align decision trees in sequence. In this implementation, a tree later in the sequence learns to “correct” errors from predictions generated by earlier decision trees. The gradient boosting learning algorithm aggregates predictions generated by the individual decision trees to generate prediction 308. Individual decision trees can be trained using a recursive splitting algorithm that splits nodes of the tree (e.g., recursive binary splitting), or any other suitable training technique. In some embodiments, machine learning component 302 can include an unsupervised learning component. For example, one or more clustering algorithms, such as hierarchical clustering, k-means clustering, and the like, or unsupervised neural networks, such as an unsupervised autoencoder, can be implemented.

In some embodiments, machine learning component 302 can be multiple models stacked, for example with the output of a first model feeding into the input of a second model. For example, an ensemble learning model can include multiple layers of machine learning models with varying architecture where the predictions output by a first model serve as input for a second model that in turn generates next predictions (e.g., prediction 308). Some implementations can include a number of layers of prediction models. In some embodiments, features of machine learning component 302 can also be determined. For example, feature engineering can be used to generate a set of features implemented by one or more machine learning models.

In some embodiments, the design of machine learning component 302 can be tuned during training, retraining, updated training, and/or testing. For example, tuning can include adjusting a number of hidden layers in a neural network, adjusting a kernel calculation used to implement a support vector machine, adjusting hyperparameters relevant to the implemented model, and the like. This tuning can also include adjusting/selecting features used by the machine learning model. Embodiments include implementing various tuning configurations (e.g., different versions of the machine learning model and features) while testing in order to arrive at a configuration for machine learning component 302 that achieves desired performance (e.g., performs predictions at a desired level of accuracy, run according to desired resource utilization/time metrics, and the like).

In some embodiments, retraining, updating the training, or retesting of the machine learning model can include training the model with updated training data or testing the model with an updated data set (e.g., data set 304 updated with new data). For example, the training data or data set can be updated to incorporate observed data, or data that has otherwise been labeled (e.g., for use with supervised learning).

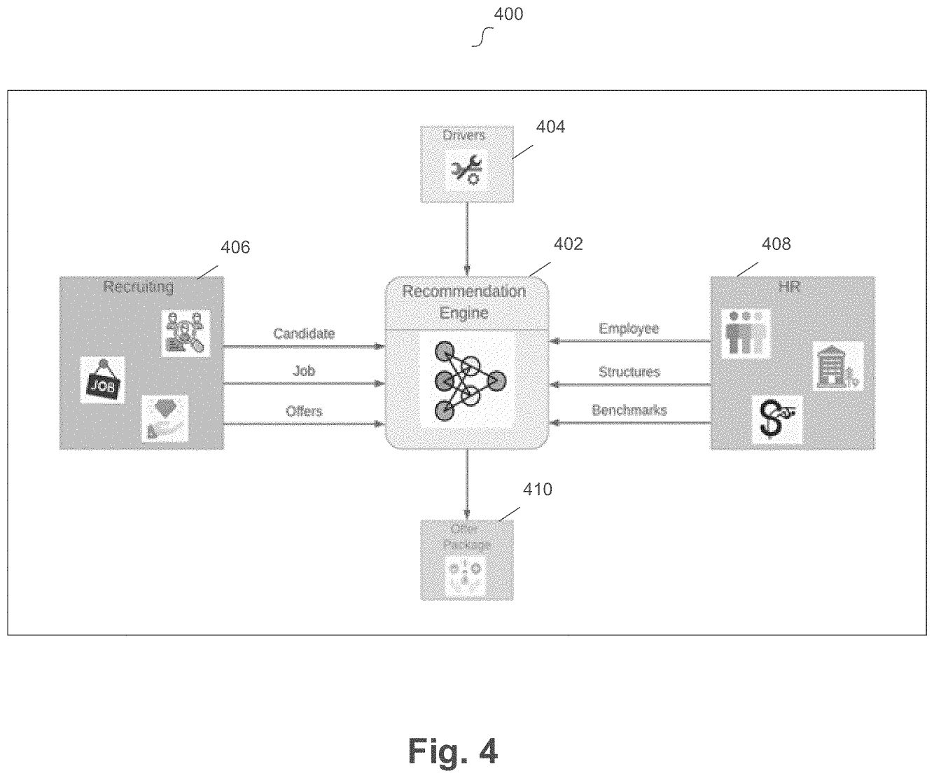

Embodiments implement an ensemble machine learning model based on data set 304, which can be data aggregated from multiple data sources (e.g., data sources across an enterprise). FIG. 4 illustrates a diagram for implementing an ensemble machine learning model according to an example embodiment. For example, diagram 400 includes engine 402, drivers 404, data sources 406 and 408, and predicted parameters 410. Engine 402 can receive or aggregate data from data sources 406 and 408, such as data related to enterprise resources. For example, the enterprise resources can be employee positions at an enterprise (e.g., data scientist, business development professional, sales lead, and the like), and data sources 406 and 408 can be different sources that store data related to the employee positions. The aggregated data set can be used to train/configure engine 402 for generating resource deployment predictions.

In some embodiments, data can also be retrieved from data sources 406 and 408 using one or more filters to generate a filtered data set. For example, the filtered data set (e.g., a distribution of the data) can be displayed to a user. In some embodiments, data sources 406 and 408 can have different levels of confidentiality requirements. For example, different access rights can be applied to data stored in data sources 406 and 408, however embodiments can selectively retrieve data from the data sources in a manner that does not violate these confidentiality requirements. For example, some stored enterprise data is confidential and/or includes security that limits access rights. Embodiments can retrieve select data from these confidential data stores for configuring a model (e.g., building a data distribution) using secure data without compromising the confidentiality requirements.

In some embodiments, data source 406 can store data for a division of an enterprise, such as enterprise recruiting. Due to the sensitive nature of enterprise recruiting data, access rights to the data source can be restricted. For example, recruiting data can include data stored about candidates for various positions at the enterprise, such as profile strength, candidate qualifications, candidate experience, internal assessment of candidate, interviews, match strength based on qualifications, match strength based on job requirements, match strength based on similar job experience, and the like. Recruiting data can also include data about job postings or requirements, such as candidates in the pipeline for the job, urgency score (e.g., period of time, available period), job location, and the like. Recruiting data can also include recruiting trends, such as accepted offers, rejected offers, locations for these positions, organizational information for these positions, and the like. Embodiments of data source 406 include data about current recruiting (e.g., open positions) as well as historic data, and can store data for business units/sectors that span the enterprise.

In some embodiments, data source 408 can store data for a division of an enterprise, such as enterprise human resources. For example, human resources data can include organizational information about the enterprise, such as job definitions, job model profiles, job grades, grade salaries, location of jobs, and the like. Human resources data can also include benchmark data, such as market surveys, other market data, geographic specific data, job specific data, and the like. Human resources data can also include employee population data, such as salary packages, total compensation packages, attrition/retention trends, and the like. Embodiments of data source 408 include human resources data about the current state of an enterprise as well as historic data, and can store data for business units/sectors that span the enterprise.

In some embodiments, engine 402 can include an ensemble machine learning model configured to generate predicted parameters 410 for deployment of a resource in a specific enterprise deployment scenario. For example, data attributes can be aggregated from data sources 406 and 408 that represent candidate quality, matching quality, pipeline quality, urgency indicator, job posting location, business unit, deployment data (e.g., salary, compensation, acceptance result), and the like. These data attributes can include historic data that represents organizational experience with recruiting, human resources, resource deployment, and other suitable experience.

Drivers 404 can serve as inputs for engine 402 that configure the display of retrieved data and/or the generated predictions. For example, drivers 404 can include an analysis period, such as the organizational span and location offsets (e.g., a slice or range of data for analysis), guard rails (e.g., minimum data sets, deviation criteria, and the like), self-tuning parameters (e.g., comparison between predictions and observed/actual data), other market influence, such as influences that may not be captured by the historic data (e.g., hiring season specifics, hot skills, and the like), and other suitable drivers.

In some embodiments, engine 402 can include machine learning model(s) that are trained/configured using the aggregated data from data sets 406 and 408 or models that are otherwise configured using this aggregated data (e.g., unsupervised learning models). For example, engine 402 of FIG. 4 can include an ensemble model that includes a regression model that estimates a range of offer values. Example features for the regression model include:
requisition location
requirement summary (e.g., job name/company internal category for the job)
requirement description embedding (see a matching score)
organization
resource quality score (e.g., quantified as weighted sum of criteria, as described herein)
resource pool quality (e.g., determine score, as described herein)
amount of time (e.g., number of weeks) the requirement has been pending (e.g., job has been posted)
amount of time (e.g., number of weeks) to resource requisition close (e.g., close of job requisition)
resource deployment failure metric (e.g., rejected offers)
resource deployment success metric (e.g., accepted offers)

In some embodiments, data for configuring/training engine 402 of FIG. 4 can be broadly sourced from enterprise groups, such as human capital, organization structures, recruiting, and the like. In some embodiments, these entity groups can provide one or more data sets to the prediction engine, and these data set(s) can be derived based on attributes of resource requisition and prediction factors. In some embodiments, human capital or human resources data can include: compensation details for a set of employees across a period, geography, job title, grade, position, business entity, and the like; attrition details across specific geography, job title, grade, position, business entity pertaining to a period of relevance, and the like; and a list of work locations within a distance (e.g., radial distance of 100 miles) from the target city and in same state or region of target city.

In some embodiments, recruiting data can include: job requisition data, such as a data set including job, grade, and location related to focus job and period; candidate and job application data, such as a focus candidate data set including profile strength relative to candidates in consideration, years of experience, assessment scores, interview ratings, and the like, match strength relative to job requisition, relevant years of experience, relevant qualifications, and the like, job applicants pipeline quality including number of candidates in pre-offer phase, number candidates across two or more phases, number of candidates across all phases prior to offer phase, and the like, candidate to job requirements match rating obtained from matching engine, candidate hiring target city, candidate interview feedback in form of ratings, and the like; candidate offers data, such as past offers relevant to the job requisition for which a candidate has applied across work locations within a distance (e.g., radial distance of 100 miles) from target city and corresponding job and grade, and the like, past offers data including department, job, grade, position, location, total salary, additional compensation, accepted, rejected, rejected reasons, and the like (within reference period).

In some embodiments, predictions can be based on resource quality (e.g., quality of the candidate for deployment scenario/job requisition), such as a resource quality score. In some embodiments, resource quality can be quantified as a weighted sum of criteria. For example, for a job requisition, the criteria can include one or more of:
Interview score (e.g., categorizing the candidate in a Likert scale);
A matching score between the candidate and the requisition;
A skill compatibility score.

In some embodiments, these scores can be used by the regression model portion of the ensemble learning model (e.g., part of engine 402 of FIG. 4). For example, these scores can be part of the data set used to train/configure the regression model (e.g., historic scores can be stored for historic candidates/offers/employees) and these score values can be received for a resource candidate for inference when predicting deployment parameters for the resource candidate.

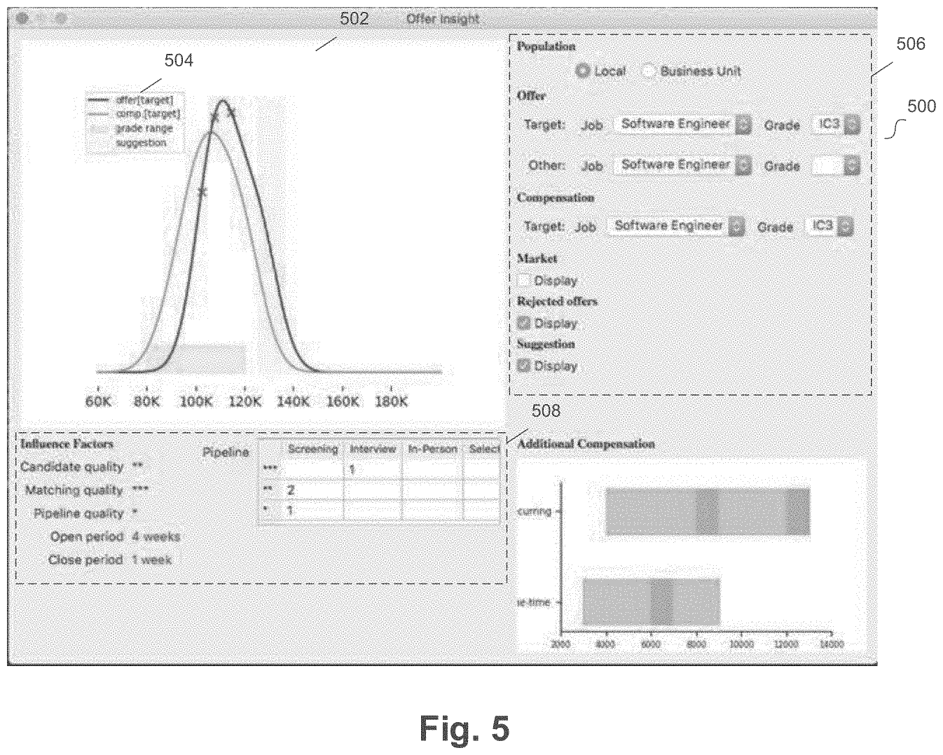

In some implementations, the matching score and skill score can provide substantiation for the interview score and thus enable a robust prediction. The matching score and skill score help users understand/explain the resource's (e.g., job candidate's) strengths and weaknesses. In some embodiments, an enterprise user that is displayed information has access to details of the quality score so the user can understand which factor contributed the output of the regression model (as illustrated in FIG. 5).

In some embodiments, the three scores cover different aspects of the resource quality. For example, an interview score can provide feedback on the person to person interaction, the matching score can measure how well the candidate's experience matches the job description/enterprise need, and the skill score can compare the resource requirements with the candidate skill.

In some embodiments, an ensemble regression model can provide a range prediction for resource deployment parameters (e.g., a range of offer values for a candidate). For example, the prediction can take into account features from the current job, current candidate, and candidate pool. In some embodiments, the ensemble model can estimate a range of offer values instead of a point estimate reflecting the uncertainty incurred in the estimate. Similar to offer, compensation, and grade range, the estimated range can be overlaid on embodiments of the user interface plot (as illustrated in FIG. 5). For example, the range can be a function of past offers and a confidence interval (e.g., 85%, 90%, 95%, and the like) can be used.

In some embodiments, an ensemble of models—one or more of interview, matching, and skill—can be combined to generate the model score for resource quality. For example, a single number (score) representing the resource quality (e.g., how well the candidate is suited for the requirements of job) can be generated. In some embodiments, the score can be mapped to a one, two, and/or three star, or other mapping algorithms can be used. In some embodiments, the data set used to train/configure the regression engine can similarly include a quality score for past candidates/offers.

In some embodiments, the interview score can be a Likert scale (0 to 5), the matching score can be a number (e.g., between 0 and 1.0 where 1.0 represent a strong match), and the skill model can generate a score (e.g., [0,1.0]) representing how well the candidate skills match the requisition's skills. Any other suitable score values, range of values, or metrics can be implemented.

In some embodiments, a resource (e.g., job candidate's) interview score for a job requisition can represent an overall performance of the candidate across multiple rounds of interview and assessments. For example, interviews can be conducted in various formats, such as one to one interviews, group discussions, behavioral interviews, situational interviews, case interviews, and the like. These interviews can be conducted by an individual or a panel. In some embodiments, the interview can be conducted by one or more experts (e.g., subject matter experts). For example, experts can provide their feedback about candidate performance during interviews on a Likert scale. In some embodiments, the interview score can be an aggregation of ratings (e.g., average, weighted average, and any other suitable aggregation) across multiple interviews.

In some embodiments, the matching score can assess a candidate resource's experience as to how it relates to the enterprise deployment scenario (e.g., job requisition). The matching score can be determined using a matching model that implements semantic textual similarity between the job requisition description and descriptive text about the resource (e.g., a candidate work profile). In some embodiments, semantic embeddings can be used, where individual words, pieces of text, or the entire text can be mapped to multi-dimensional dense vectors. Those vectors can be constructed so that the “closer” they are the higher the semantic relation.

For example, for a cloud software engineer position, a hypothetical candidate A can possess experience developing for Oracle Cloud and Amazon Web Services. Hypothetical candidate B can have experience developing the web site infrastructure of an e-Commerce company. Hypothetical candidate C can have enterprise software expertise. In some embodiments, the job description and candidates experience text description can be mapped to dimension vector (e.g., high dimension vector) using a machine learning model, such as neural network models.

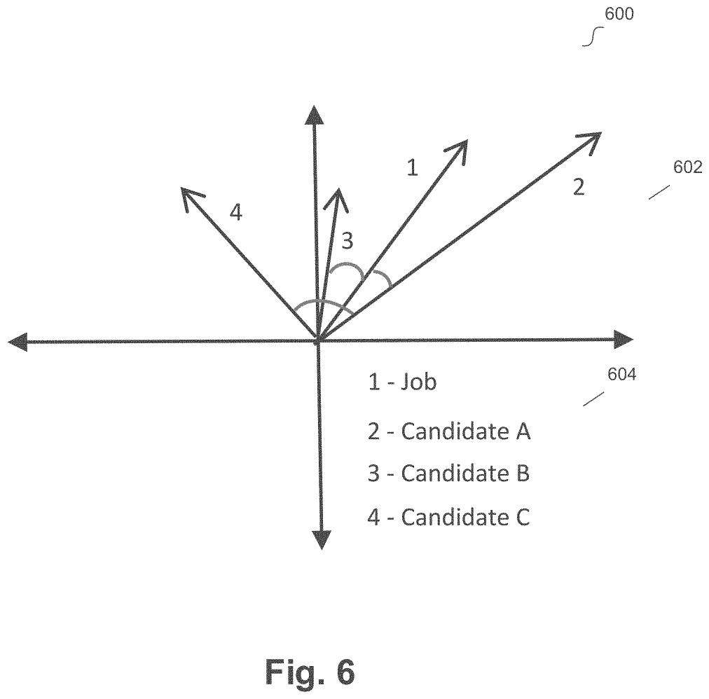

For example, the relation among these vectors can be illustrated by projecting them onto a two-dimensional plane (e.g., via t-distributed stochastic neighbor embedding (“t-sne”), principal component analysis (“PCA”), or any other technique that can reduce or map the dimensionality of data). FIG. 6 illustrates a relation among vectors according to an example embodiment. Visualization 602 and legend 604 demonstrate vectors (e.g., projected onto a two-dimensional plane) for a job description and descriptions of experience for hypothetical candidates A, B, and C. Visualization 602 illustrates the relative distances between these vectors, which can be used as a proxy for semantic similarity in embodiments.

In some embodiments, semantic embeddings can be generated by one or more machine learning models. Because of the inherent complexity of natural language, models are often trained on a large amount of data. The availability of large training data can cause challenges the enterprise software industry, where enterprises often belong to multiple business domains and even large enterprises do not have enough data to properly train complex models. One approach to address the need for large training datasets—which is generating impressive results in computer vision—is transfer learning. Using transfer learning, models and trained using a generic large corpus of data, and then these trained models are further refined on specific domain and task data. One additional benefit is that this generic model can create a strong baseline, which can help reduce the effort required for generating models for specific implementations (e.g., the cold start problem).

In some situations, the labeled data required for supervised learning can cause challenges in implementations. Embodiments can also use unsupervised models to generate semantic embeddings for words or sentences (documents). Word based models generate semantic embeddings for individual words. There are different strategies to combine those word embeddings to generate an embedding representing a sentence or document. Some sample models, algorithms, and techniques include word2vec, Glove, and FastText. Several extensions to those models have been developed, but most rely on the distributional hypothesis: words that occur in the same context tend to have similar meaning. Although those models provide strong baselines (e.g., SIF and p-mean) they exhibit some weakness. One of the main constraints of those models is the static nature of the embeddings. A word embedding represents the most common sense of the work in the training corpus. This model cannot address polysemy. Another limitation of these models is the use of a “bag of words” technique when composing the word embeddings. This means that the word order is taking into account which may affect significantly document embedding.

Some techniques have attempted to minimize these issues. For example, Doc2Vec (Doc2VecC) and Sent2Vec generated embedding from the entire sentence, however the static word embeddings were still part of the models. Context based embedding like ELMO and BERT use deep learning models to not only take into account the context but also influence of distant words. Supervised embedding models, like Universal Sentence Encoding, trained in multiple Natural Language Processing tasks generate embedding which have increased the performance of the semantic similarity metric.

Some embodiments implement a combination of two model strategies to address the multiple domain, training data availability, and cold start problem. For example, word embedding composition (pooling) model(s) trained on a large public corpus of data can be used in combination with a contextual embedding model. The former model can provide a strong baseline which yields good results and the latter can be fine-tuned to the enterprise domain once is in the system/available. For example, the combined score can be generated for resource descriptions (e.g., job candidate descriptions) and job descriptions. The matching score can be calculated as function of a distance metric between job and candidate embeddings.

In some embodiments, the skill model can receive a text representation of the job description and/or candidate experience, and can extract relevant skills from these descriptions. For example, the model can generate a score ([0,1.0]) representing how well the candidate skills match the requisition's skills requirements. As part of the score calculation, the model can identify and weigh a candidate's skill with the objective of providing a better score to specialized candidates or candidates who are currently exercising those skills. In some embodiments, the skills mode can be used to identify similar candidates.

In some embodiments, the resource pool quality model provides single number representing the quality of the resource pool. The pool quality can be an average quality score discounted by the phase of the resource deployment flow. For example, the pool quality score can be a function of the number of candidates in the deployment flow discounted by the phase of the flow for each candidate (e.g., earlier phases can include a larger discount value). In some embodiments, models or algorithms for the resource pool quality can be based on historical data of similar requisitions. For instance, it may be beneficial to have a larger number of qualified candidates for requisitions with stringent hiring criteria as many of the candidates may not meet the criteria.

In some embodiments, multiple models can be trained using the aggregated data—one trained on global resource data (e.g., across the enterprise's employee population) and one trained on a subset of the enterprise resources, such as division specific models trained on division specific resource data. For example, predictions from multiple trained models can provide flexibility to resource deployment parameters (e.g., salary ranges) based on divisional data for large organizations where divisions operate independently.

Once the model(s) are trained or configured on the aggregated enterprise data, the trained/configured model(s) can be used for inference. For example, predictions for deployment specific to a resource (e.g., candidate in a recruiting flow) can be generated. In some embodiments, data that is similar to the aggregated data set but specific to a job candidate (or multiple job candidates) can serve as input to the trained/configured model(s). For example, a job candidate can be considered for one or more current job postings, and the data relevant to the specific job candidate and current job posting(s) can be used. In some embodiments, data attributes that can serve as input can be candidate quality, matching quality, pipeline quality (e.g., specific to the job position(s) that candidate is being considered for), urgency indicator (e.g., specific to the considered job position(s)), job posting location (e.g., specific to the considered job position(s)), business unit (e.g., specific to the considered job position(s)), and the like (e.g., features that are similar to the features of the data set used to train/configure the models).

In some embodiments, for a given job candidate, engine 402 can generate a predicted salary range using offer acceptance criteria as a target for the prediction (e.g., an administrator can configure the prediction engines and/or a user interface that visualizes generated predictions to generate/depict a salary range with predicted acceptance rates between 60%-80%). In this example, given the information about the specific job candidate and the acceptance rate, prediction engine 402 can provide the compensation ranges that match the desired acceptance rates.

Without loss of generality, embodiments can similarly be used to provide recommendation for other compensation elements such as one-time bonus, and recurring bonuses. Other embodiments can generate resource deployment parameters for other resources. For example, resources other than a job candidate/employee, such as a SaaS tool, can similarly be implemented. In some embodiments, engine 402 can include any number of mathematical and/or machine learning models, such as density estimation, candidate equality models, candidate pool quality models, regression models, and the like.

In some embodiments, a target candidate can be a candidate who has applied for a job and an offer determination is being made. A target job can be a job for which the target candidate has applied. Target grade can be a proposed grade for a target candidate. A target city can be a city of proposed work location for the target candidate. A reference period can be a date period spanning the current date and a past date (e.g., up to the past twelve months, or more). In some embodiments, one or more of the target job (e.g., position), target grade (e.g., or a range of grades), target city or cities, and/or reference period can be used as filters/qualifiers when retrieving/aggregating data (e.g., from data sources 406 and 408). For example, data that matches one or more of these filters/qualifiers can form a filtered data set returned from data source 406 and/or 408.

In some embodiments, data can be retrieved for relevant offers (e.g., in the past) from one or more of data sources 406 and 408 by filtering past resource deployment data (e.g., accepted and/or rejected) with one or more of the following example filters:
Look back period (e.g., duration of time)
Job
Grade
Location
Organization
Minimum count
Source data period
Currency

In some embodiments, the result can be a filtered data set of resource deployment information (e.g., job offer parameters) and results (e.g., whether the offer was accepted or reject). The offer values or a subset of the offer values (e.g., accepted offer values) can be fed into one or more models (e.g., engine 402 of FIG. 4) which can estimate a density for the data. For example, one or more models (e.g., kernel density estimation (“KDE”) model) can be configured using historical data. For example, the intuition can be to find past offers for similar jobs and their results. The model(s) can estimate the population distribution from which the past offers can be sampled.

Based on the output of the model, embodiments of a user interface can plot selected resource deployment information (e.g., accepted offer distribution) by defining a value range. In some embodiments, the density is calculated for specific points in the range and the plot can be created by interpolating the density points. In some embodiments, once the value distribution (e.g., accepted offer distribution) is determined, the model can be used to overlay selected resource deployment information by defining another value range (e.g., rejected offer values) on the density plot. For example, the density can be estimated for each rejected value and this density can be marked on the accepted offer distribution. In some embodiments, the accepted and rejected offer information can be merged in a single visual element, however focus can be placed on the accepted offer distribution. The user interface depicted in FIG. 5 depicts the relevant data in some embodiments.

FIG. 5 illustrates a user interface for visualizing predictions for resource deployment according to an example embodiment. Embodiments include providing an enterprise user, such as a hiring manager or recruiter, with a visualization tool that that overlays resource data. For example, a hiring manager can be provided with a visualization tool that overlays one or more of the current salary of employees, the offers made to past candidates, the company defined range for the job/grade, and the predicted salary range of the offer (e.g., generated by engine 402/the ensemble machine learning model). User interface 500 includes visualization 502 that displays an example of offer and compensation distributions created with KDE in accordance with some embodiments. User interface 500 also includes legend 504, population selections 506, and factors 508. Legend 504 includes data attributes related to the prediction generated by engine 402 of FIG. 4 and the data depicted in visualization 502. For example, legend 504 can label the target offer, target compensation, grade range for the position, and predicted parameters for the resource deployment (e.g., job offer compensation range).

Population selections 506 can configure visualization 502 and engine 402 of FIG. 4, such as with a selection of a local or global version of machine learning model (e.g., machine learning model of engine 402 trained with either enterprise wide data or division/business unit specific data). Population selections 506 can also include selection of filters/qualifiers for retrieving a filtered data set, such as the target job/position (e.g., job data used to generate predictions), other job/position (e.g., other/similar job data used to generate predictions), and job/position specific compensation data for visualization 502.

In some embodiments, factors 508 display certain factors that influence the parameter predictions generated by engine 402 of FIG. 4. For example, candidate quality can be part of the data set used to train/configure engine 402 (e.g., using historical data) and can be part of the input used to generate specific predictions (e.g., using specific data relevant to a current candidate).

In some embodiments, user interface 500 can visualize data from multiple sources. The data can be processed (e.g., using engine 402 of FIG. 4) and rendered as graphical components providing a compact overview of factors supporting resource deployment. A user can obtain additional information on the data behind the graphical component, which provides further insights.

In some embodiments, the user interface and/or prediction engine can provide visual information about the current resource deployments (e.g., compensation of current employees) or past resource deployments. The compensation information can be subject to constraints that maintain confidentiality (e.g., minimum amount of information/number of employees, as described with reference to offer distribution). The plot can be generated by the flow described with reference to the offer distribution, as illustrated in visualization 502.

In some implementations that relate to jobs, a job can have multiple grades where each grade has a range of compensation values specified by a minimum and maximum values (e.g., set by the enterprise). In some embodiments, this range can be displayed along with the offer and compensation plot. For example, the minimum and maximum values can be retrieved based the job grade and currency. In some embodiments, the user interface can display a graphical component representing the range from minimum and maximum value and overlay it on the offer and/or compensation plot.

Graphical visualization of information, such as visualization 502 of FIG. 5, has become a part of enterprise decision support tools. For example, in a job candidate resource deployment example, a distribution of past offers, current salary, and compensation can provide hiring managers and recruiters with information supporting the offer flow. An example from for distribution visualizations is histograms, however histograms can be dependent on certain parameters, such as bin selection. For example, small modifications to bin definitions can lead to significant changes in the histograms. To address this shortcoming, embodiments leverage visualization that use Kernel Density Estimators (“KDEs”). KDEs can provide smoothing to a histogram by summing up contributions from neighbors weighed by a kernel. In other words, this can create a visualization that is less dependent on parameters.

In some embodiments, the visualization of the distribution allows users to easily evaluate beneficial resource deployment ranges of values. Two aspects of KDEs that affect visualization are bandwidth parameter and kernel selection. For example, bandwidth parameter can control how the distance to surrounding points (e.g., offer, salary compensation, and the like) affects the density estimation for a point. One can interpret length of the bandwidth as a tradeoff between bias and variance: a larger bandwidth would be affected by farther points leading to a flatter distribution (but larger degrees of bias) while a small bandwidth will be affected by closer points leading to improved bias (but larger degrees of variance). Embodiments can implement certain rules-of-thumb for the bandwidth estimation. In addition, as data enters the system (e.g., once enough data is available), bandwidth parameters that result in optimal display can be determined.

In order to obtain a distribution of past resource deployment parameters (e.g., job offer values) information about past resource deployment parameters (e.g., job offers) meeting relevant criteria can be retrieved. In some embodiments, the criteria can include the list of filters/qualifiers relevant to the target candidate and target job/position. With regard to the relevant criteria, it is possible that the criteria restricts the data to a small number of resources which may allow for inference of private compensation information that is meant to be kept confidential in some embodiments. In order to prevent such case, a minimum number of offers can be required. For example, if such minimal number is not available, the offer distribution information can be withheld.

In some embodiments, select data can be retrieved from data sources 406 and 408 in a manner that does not compromise confidentiality. For example, a qualifying data set may not be directly returned/displayed to the user. In some embodiments, the qualifying (filtered) data set is aggregated, and averages are computed, such as based on a resulting data set, minimum values, maximum values, and/or average values for offered compensation (e.g., salary). Additional compensation (e.g., one-time bonuses) offered can also be computed and displayed to the user. Embodiments thus ensure confidentiality of data at least because a user viewing this information cannot associate confidential data to a specific employee or candidate.

In some embodiments, a guard rail mechanism for ensuring confidentiality can also be implemented (e.g., a guard rail defined as one of drivers 404). For example, if the resulting data set fails to meet a guard rail criteria (e.g., returns data for a number of employees/individuals that is less than a threshold, such as 4, 5, 6, 10, and the like) the data is not displayed to the user. In some embodiments, the confidentiality requirements/guard rails can be implemented separately for each data source with access restrictions (e.g., data sources 406 and 408). For example, if the data set returned by data source 406 fails to meet the guard rail criteria, this particular data set may not be used to generate predictions or be displayed to the user. In another example, if the data set returned by data source 408 fails to meet the guard rail criteria, this particular data set may not be used to generate predictions or be displayed to the user. In some embodiments, the user can be presented with a message, such as “Insufficient data”. Embodiments thus ensure confidentiality by selectively not displaying data when there is a risk for association with individual employees. In addition, the guard rail criteria can maintain confidentiality per data source in some embodiments and thus preserve access restrictions for the individual data sources themselves.

In some embodiments, a user can selectively include filters/qualifications for other positions, grades, locations, and any other suitable qualifying value, for example to aggregate data for other or additional employees/positions/jobs. For example, an “other Job or Grade” option can be provided and utilized by a user when aggregating a data set. This option can be used when a particular set of filters/qualifications does not retrieve sufficient data or for the user to explore alternate jobs or grades to match the focus of a candidate profile. In these embodiments, confidentiality can be maintained by presenting data and predictions that cannot be directly associated to any specific employee or candidate.

In some embodiments, when a “limited” data set of confidential data (e.g., a data set that does not meet a confidentiality criteria, or the guard rails) is returned based on original filters/qualifications (e.g., specific job, grade, and location), the filters/qualifications can be broadened to return a larger data set. For example, the larger data set can be retrieved by broadening the filters/qualifications (e.g., adding additional jobs, grades and/or locations) used to retrieve the data. In some embodiments, the distributions for the larger data set and the limited data set can be compared.

For example, the two distributions can be compared using the Mann-Whitney U test, where one or more statistics based on the two distributions (e.g., U, U₁, and/or U₂) and a characteristic about the statistic(s) (e.g., effect size, such as common language effect size) can be calculated, along with statistics about both distributions (e.g., means, medians, sample sizes, and the like). A similarity criteria can be defined for these calculated values that includes thresholds, permitted ranges, and/or additional metrics defined by a function or expression. For example, a set of the calculated values for the two distributions (e.g., U, U₁, U₂, effect size, means medians, samples sizes, and/or other relevant values) can be evaluated using the similarity criteria, where the distributions can be deemed “similar” when the calculated values meet the similarity criteria (e.g., when one or more of the values (or additional metrics calculated based on the values) are within permitted ranges, above/below thresholds, and the like). In some embodiments, other statistical evaluations, such as non-parametric statistical tests (e.g., Welch's t-test) can similarly be used to compare the distributions.

If the comparison meets the similarity criteria (e.g., indicating the distributions are similar or not significantly different), it can be determined that the distribution for the larger data set can be used as a proxy distribution for the limited data set (e.g., filtered according to the original filters/qualifications). In some embodiments, when the comparison meets the similarity criteria, the distribution determined for the larger data set can be used in place of the distribution for the limited data set. For example, the displayed data distribution (e.g., displayed by a visualization similar to the one illustrated in FIG. 5) can be based on the distribution for the larger data set. Accordingly, embodiments both preserve confidentiality by utilizing the larger data set while maintaining proximity to the original limited data set by ensuring the two data distributions meet the similarity criteria. Accordingly, when a specific set of filters/qualifications results in the return of a limited data set, embodiments can implement improved and robust filtering, selection, and confidentiality maintaining processing techniques to return useful results and provide context for the predicated deployment parameters to a user.

In some embodiments, the broadened filters can be selected by the user, such as by selecting an additional grade or location that can be used to broaden if the initial returned data set does not meet the criteria for maintaining confidentiality. For example, the selected additional grade or location may not be used to retrieve data until after the initial data set is returned and it is determined that this initial data set does not meet a confidentiality criteria. In some embodiments, suggested broadened filters can be displayed to aid the user's selection.

Embodiments are implemented in the midst of the hiring flow at a decision-making stage that has impact on the organization and individual candidate. An example hiring flow can include multiple groups of sub-flows. The grouping of sub-flows can be guided by functions of sub-flows and commonalty of its one or more functions. Flow groups include requisition management or requisition lifecycle, candidate application process or candidate selection process, offer management or offer lifecycle, candidate review and response, and human resources flow can be tied together to form an overarching hiring flow.

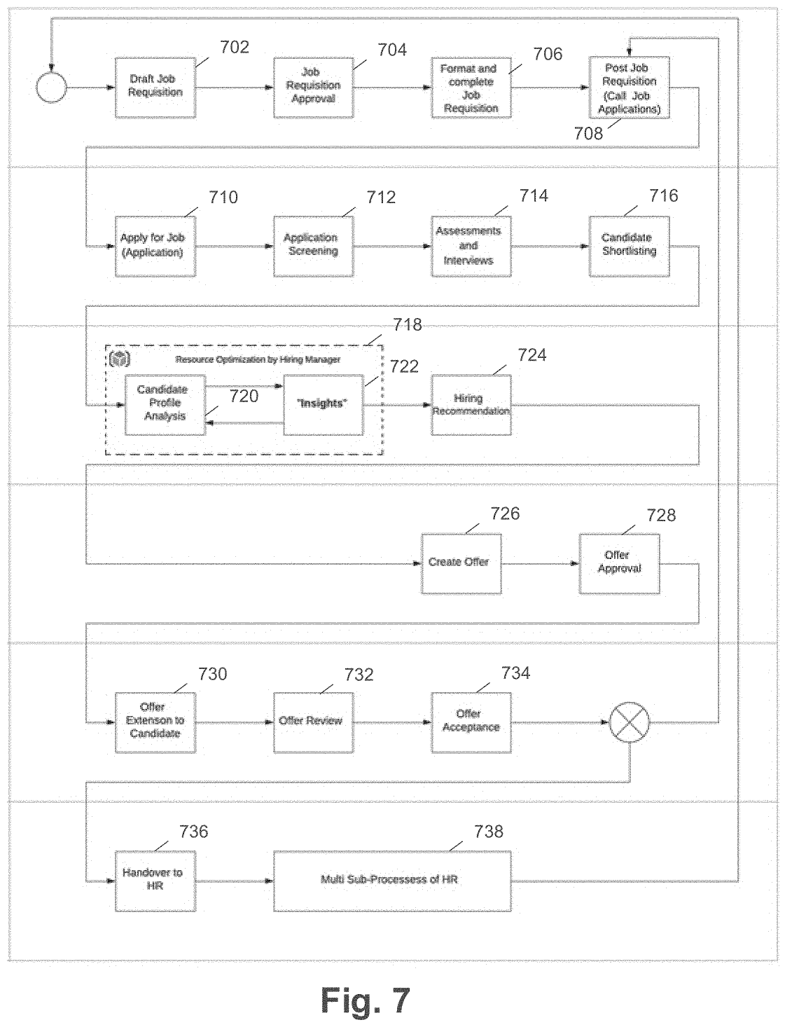

FIG. 7 illustrates a flow diagram for an enterprise job requisition according to an example embodiment. In one embodiment, the functionality of FIGS. 7-9 is implemented by software stored in memory or other computer-readable or tangible medium, and executed by a processor. In other embodiments, each functionality may be performed by hardware (e.g., through the use of an application specific integrated circuit (“ASIC”), a programmable gate array (“PGA”), a field programmable gate array (“FPGA”), etc.), or any combination of hardware and software. In embodiments, the functionality of FIGS. 7-9 can be performed by one or more elements of system 100 of FIG. 1, system 210 of FIG. 2, and/or system 300 of FIG. 3.

Embodiments can be implemented in support of the resource deployment flow illustrated in FIG. 7. A job requisition sub-flow can be represented by 702, 704, 706 and 708. The job requisition sub-flow is a flow group where the life cycle of a requisition is managed. Requisition lifecycle flows through drafting a job requisition (at 702), its review and approval (at 704), formatting job requisition (at 706), and publishing the job requisition (at 708). The functionality of the lifecycle can be performed by a specific sub-flow. A sub-flow is kicked off based on previous sub-flow completion and outcome and also sets its own outcome.

At 702, draft job requisition is a flow where a job requisition is drafted based on previous triggers, where these triggers set the job requisition life cycle in motion. Job requisitions can be drafted per specific requirements of a job for which a candidate is sought. A job requisition can contain a multitude of information for publishing a job and performing other processes. Predictions generated by embodiments are the result of one such flow that consume bits of information from a job requisition.

At 704, the flow proceeds to job requisition approval once a drafted job requisition is submitted for approval. Approval submission requests layout approval routing and identify designated approvers at one or more stages of the approval flow. Routing of the approval can be dynamic and guided by rules. Rules can be resolved based on the data that is set in the job requisition that kicked this approval flow. The outcome of this flow can move the example hiring flow forward or backward. A forward move triggers the next phase for formatting the job requisition at 706. Augmenting details can be added to the definition of a job requisition. This phase can enrich the requisition for attracting talent for hiring. An enriched job requisition is set for posting or publishing a job requisition at 708.

Post job requisition 708 is the flow in which a completed job requisition is set in motion to attract candidates. In this flow the requisition posting vector can be set, such as time period and direction of exposure. For example, a specific start and specific end time can set the exposure time period, and internal posting or external posting or both can set the direction of exposure of the job requisition to attract a candidate. A posting vector can be an input to the prediction engine of embodiments.

A candidate application sub-flow can be represented by 710, 712, 714, and 716. Candidate application is an example flow group orchestrating a life cycle of a candidate's application. A candidate application flow can be sub-grouped into two distinct flows, namely candidate application and selection. At 710 a job application can be completed and submitted by a candidate as a response and expression of interest for a specific job posted. Details pertaining to the candidate and job applications forms the profile of a candidate and job application. This profile representing the candidate and job application can an input to the prediction engine in some embodiments.

Candidate selection is a subgroup by itself including sub-flows, namely Application screening at 712, Assessments and Interviews at 714, and Candidate shortlisting at 716. The candidate selection flow provides the framework to move candidates through the resource deployment flow to evaluate and find the best candidates for a job. When candidates apply for a job, the candidate selection flow tracks and manages candidates from the time their job application is confirmed to the time that they're hired. An analogy can be drawn between the candidate selection flow and moving candidate resumes from one pile to another as the selection progresses and the number of resumes retained is reduced. For example, a candidate job application is analyzed, the candidate is contacted, interviewed, then shortlisted for hiring.

Application screening at 712 involves review of qualitative and quantitative candidate facts in context of the job requisition. This review outcome selectively moves the application forward for assessments and interviews or towards and end state of rejection. During this flow the relevant qualifications, experience. and achievements are identified. This set of relevant data can be an input to the prediction engine in some embodiments.

Assessments and Interviews at 714 is a phase in the hiring flow where relevant assessments and interviews are orchestrated. An assessment flow assesses and measures the knowledge, skills, abilities, and attributes of the candidate for the job. Outcome of the assessment qualifies the candidate to move to the interview flow. Interviews can be scheduled with subject matter experts, human resources professions, hiring manager, and other suitable interviewers. Interviews can be conducted in various formats like one to one interviews, group discussions, behavioral interviews, situational interviews, case interviews, and the like. These interviews can be conducted by an individual or panel of interviewers. Interviewers can provide their feedback about candidate performance during interviews on a Likert scale. For example, average rating across interviews can be represented as an interview score. Interview score can be an input to the prediction engine in some embodiments.

Candidate shortlisting at 716 is the flow in which a candidate job application and associated actions and artifacts are reviewed, such as a review that spans across candidate profile, assessments, interviews and any other flows and artifacts deemed relevant during the selection flow. A set of shortlisted candidates can be further passed on for hiring decisions.

A hiring optimization sub-flow can be represented by 718, 720, 722, and 724. The hiring optimization flow can be when a hiring manager carries out resource optimization 718 across the shortlisted candidates to arrive at a compensation package for candidates. A compensation package includes salary and additional compensations for the relevant job. A total compensation package can be influenced by multiple factors like job definition, hiring grade, hiring location, relevant salary ranges as specified by the organization, current compensation levels within organization, past offer trends, current market trends, hiring budget, urgency, hot skills, and many others. Arriving at a compensation package can be a fine balance over and above the influencing factors.

This process of resource optimization to arrive at a hiring decision has a significant impact on the enterprise and candidate. Resource optimization includes critical analysis of candidates in conjunction with available compensation. Embodiments of the prediction engine provide candidate profile analysis 720 and insights 722 for the optimization flow. In some embodiments, algorithms can consume the candidate profile and other relevant inputs, further described herein. The prediction engine can then generate a compensation range package.

In some embodiments, the output from the prediction engine can be a visualization. For example, a hiring manager can analyze the set of candidates and their predicted parameters (e.g., compensation package). In this example, the hiring manager can take action to deploy a new resource (e.g., hire a candidate) based on the best fit candidate, compensation package and related terms.

A job offer sub-flow can be represented by 726 and 728. In some embodiments, the predicted parameters for the resource (e.g., hiring recommendations) form the inputs for creation of a resource deployment action for the resource, or a job offer for the candidate at 726. In some implementations, a resource deployment action (e.g., job offer) is subject to certain approvals. In some embodiments, the predicted parameters (e.g., hiring recommendation) is automatically consumed by the prediction engine (for next iterations).

In some embodiments, approval workflows at 728 are designed for approvals and routing based on rules. Outcome of an approval workflow is approval or rejection of the offer. In some embodiments, the approval outcome can be automatically consumed by the prediction engine during its next iteration. In a job offer implementation, an approved offer can be extended to a candidate for review and acceptance.

A candidate review sub-flow can be represented by 730, 732, 734, and 736. The approved offer can be extended to the candidate at 730. At 732, the candidate can review the offer. At 734, the candidate can accept or reject the offer. In some embodiments, candidate decision of acceptance or rejection of the offer can be automatically consumed by the prediction engine (for next iterations). In some embodiments, a rejected offer reverts to 708, where the job posting is again published. An accepted offer proceeds to a hiring sub-flow, represented by 736 and 738.

On acceptance by candidate, the candidate profile along with the offer can be handed over to further hiring flow (e.g., where a new hire flow can be implemented) at 736 and 738. In some embodiments, new hire data as an employee can be automatically consumed by the prediction engine (for next iterations).

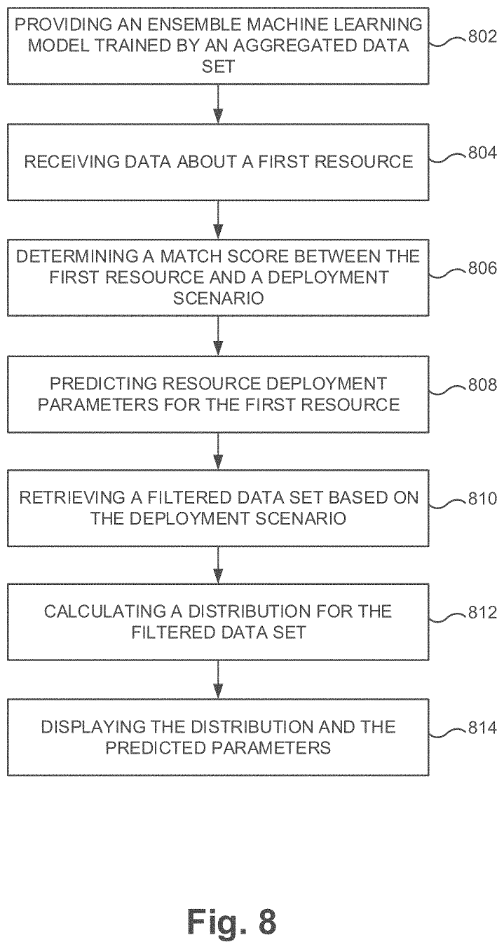

FIG. 8 illustrates a flow diagram for generating resource deployment predictions using an ensemble machine learning model according to an example embodiment. At 802, an ensemble machine learning model trained or configured by an aggregated data set can be provided, where the aggregated data set includes data about resources deployed in enterprise deployment scenarios aggregated from a plurality of enterprise sources. For example, the resources can be employees of an enterprise and the enterprise deployment scenarios can be position(s) held by the employees (e.g., along with specific details about the positions, such as location, grade, and the like). In some embodiments, the aggregated data set can also include candidate resources for a position at the enterprise and results for a job offer to the candidate resources. For example, the data about resources deployed in enterprise deployment scenarios can be historic data. In some embodiments, the data can be aggregated from a plurality of sources (e.g., enterprise divisions), and the data aggregated from at least two enterprise divisions can include different sets of access restrictions.

At 804, data about a first resource including natural language data and numeric score data can be received. For example, the first resource can be a job candidate for a first enterprise deployment scenario. The natural language data can be data descriptive of the candidate's job experience and/or skills.

At 806, a matching score can be determined between the first resource and a first enterprise deployment scenario based on at least a matching between natural language data descriptive of the first resource and natural language data descriptive of the first enterprise deployment scenario. For example, matching the natural language data descriptive of the first resource and the natural language data descriptive of the first enterprise deployment scenario can include generating context based embeddings and calculating a distance between embeddings for the natural language data descriptive of the first resource and embeddings for the natural language data descriptive of the first enterprise deployment scenario.

In some embodiments, the matching can be performed by an ensemble machine learning model. For example, the ensemble machine learning model can include a natural language processing model that determines a numeric matching score based on contextual embeddings.

At 808, resource deployment parameters can be predicted using the ensemble machine learning model based on the determined matching score and the received numeric score data about the first resource. For example, the predicted resource deployment parameters can be a compensation range for the first resource in the first enterprise deployment scenario with a predicted probability of success that meets a criteria.

In some embodiments, the ensemble machine learning model can include a regression model and a natural language processing model that determines a numeric matching score based on contextual embeddings, where the output of the natural language processing model is fed into the regression model. For example, input for the regression model can be the numeric matching score from the natural language processing model and the numeric score data received about the first resource.

At 810, a filtered data set can be retrieved from a plurality of enterprise sources based on the first enterprise deployment scenario. For example, the first enterprise deployment scenario can be a job position at the enterprise and the filtered data set can be data about the job position across a plurality of enterprise divisions. In some embodiments, the plurality of enterprise sources can be enterprise divisions, and the filtered data set can be retrieved from at least two enterprise divisions that include different sets of data access restrictions. In some embodiments, the filtered data set can be retrieved from the plurality of sources using a set of filters based on the job position. For example, specific parameters for the enterprise job (e.g., business unit, division, grade, location, and the like) can be used as filters to retrieve the filtered data set from the sources.

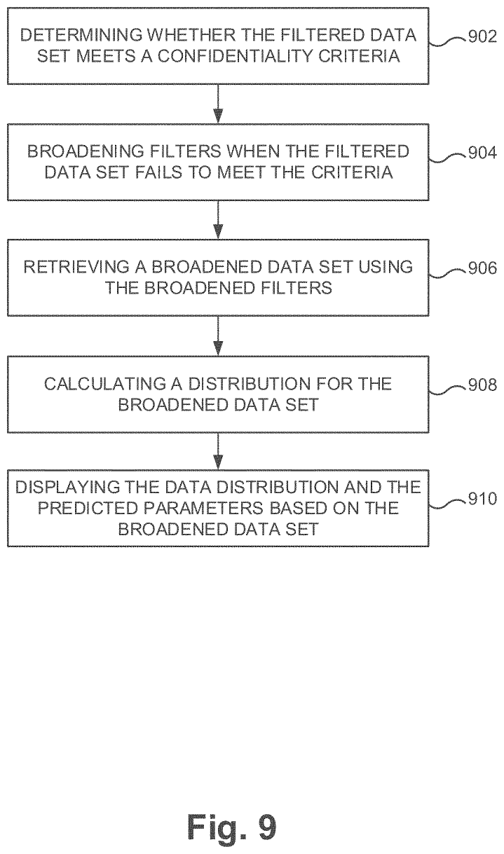

In some embodiments, it can be determined whether the filtered data set about the first enterprise deployment scenario meets a confidentiality criteria. When the filtered data set meets the confidentiality criteria, the data set can be used by embodiments to calculate a distribution and display results to a user. When the filtered data set fails to meet the confidentiality criteria, embodiments can use additional techniques to return results that maintain confidentiality. For example, the flow of FIG. 9 can be implemented to return results that maintain confidentiality.

At 812, a distribution of the filtered data set can be calculated. For example, the distribution can be a histogram, KDE, or any other suitable distribution for the filtered data set. At 814, the calculated distribution of the filtered data set and the predicted resource deployment parameters generated by the ensemble machine learning model can be displayed to a user.

For example, the distribution can include a range of offer values for historic offers extended to candidate job seekers and/or historic compensation data for employees of the enterprise. In some embodiments, because the filtered data set is retrieved based on the first enterprise deployment scenario, the calculated distribution can be pertinent to the enterprise job and position sought by the first resource. For example, the predicted resource deployment parameters generated for the first resource based on the first enterprise deployment scenario can be superimposed or otherwise displayed along with the distribution such that the distribution provides visual context for the prediction(s). In some embodiments, the predicted resource deployment parameters are a range of offer values, and the range of values can be superimposed on the displayed distribution. In some embodiments, a visualization of the distribution of the filtered data set and the predicted resource deployment parameters can be displayed.

FIG. 9 illustrates a flow diagram for generating resource deployment predictions using an ensemble machine learning model and a broadened data set according to an example embodiment. At 902, it can be determined whether the filtered data set meets a confidentiality criteria. For example, retrieving data about the first enterprise deployment scenario can include retrieving data from the plurality of sources using a set of filters based on the job position. In some embodiments, the filtered data set fails to meet the confidentiality criteria when the number of resources that match the filters is less than a threshold. For example, if few resources match the threshold, the identity or identities of the resources may be discernable, which may violate confidentiality requirements.

At 904, when it is determined that the filtered data set fails to meet the confidentiality criteria, one of more of the filters used to retrieve the filtered data set can be broadened. For example, retrieving data about the first enterprise deployment scenario can include retrieving data from the plurality of sources using a set of filters based on the job position. In some embodiments, broadening the filters used to aggregated data can include adding filter parameters that match other job positions similar to the job position (e.g., job positions at nearby salary grades, different locations, other business units, and the like).

At 906, data can be retrieved using the broadened one or more filters to generate a broadened filtered data set. For example, the broadened filtered data set can be larger than the filtered data set. At 908, a distribution can be calculated using the broadened filtered data set.

At 910, the distribution of the broadened filtered data set and the predicted resource deployment parameters generated by the ensemble machine learning model can be displayed to a user. For example, the calculated distribution that is displayed to a user can be calculated based on the broadened filtered data set when the broadened filtered data set meets the confidentiality criteria and a difference between distributions for the broadened filtered data set and the filtered data set meets a similarity criteria. In some embodiments, a visualization of the distribution of the broadened filtered data set and the predicted resource deployment parameters can be displayed.

Embodiments generate resource deployment predictions using an ensemble machine learning model. For example, enterprises can deploy a mix of resources in a variety of circumstances, such as software as a service (“SaaS”) tools, people resources, physical tools (e.g., vehicles, robotic equipment, and training equipment), and the like. With the rise of resource types, specializations, and complexity, predictions about resource deployment that rely on enterprise and resource data sets can increase the likelihood of success when deploying a new resource or re-deploying an existing resource.

Embodiments provide an ensemble machine learning model trained or configured by an aggregated data set to predict deployment parameters for a candidate enterprise resource. For example, the aggregated data set can include data about resources deployed in enterprise deployment scenarios (e.g., historic data) aggregated from a variety of enterprise sources. An enterprise can have a number of divisions, departments, or business units. In some embodiments, the aggregated data can be based on natural language data and numeric data. For example, a job profile and/or an employee/candidate profile can include natural language descriptions. In another example, an employee's or candidate's evaluation can include numeric score data (e.g., from 1-5). These different data formats can be processed and aggregated into a data set for machine learning.

Embodiments can also receive data about a resource that is a candidate for deployment. For example, the data about the candidate for deployment can also include natural language data and numeric data. In some implementations, the resource can be a candidate or employee for a certain job position at the enterprise. The received data about the candidate can include a natural language profile that is descriptive of the candidate and numeric scores (e.g., interview scores) about the candidate.

Embodiments can determine a match score between the candidate resource and the enterprise deployment scenario. For example, a description of a job can be compared to a job candidate's qualifications. In another example, a description of software requirements can be compared to a description of a SaaS tool. Other suitable data can be used to match the candidate resource with the deployment scenario.

In some embodiments, parameters for the resource deployment can be predicted using the trained or configured ensemble machine learning model based on the determined match score and numeric score about the candidate resource. For example, parameters can be predicted for a job offer for the candidate resource, such as compensation and other suitable job parameters. In another example, parameters for how a SaaS tool can be used with existing systems can be generated. Embodiments predict resource deployment parameters using the ensemble machine learning model with a likelihood of success, thus reducing the effort required to deploy enterprise resources.

In some embodiments, filtered data can be retrieved from various enterprise sources based on the enterprise deployment scenario. For example, the enterprise deployment scenario can be a job position at the enterprise, and filters related to the job position can be used to retrieve the filtered data set. In some instances, enterprise data for a given division, department, and/or business unit can be subject to access restrictions due to confidentiality requirements. For example, confidentiality can be required by regulation (e.g., for human resources) or part of an enterprise policy (e.g., for sensitive business data). Embodiments selectively filter data from these different data sources such that confidentiality requirements are not compromised.

In some embodiments, a distribution can be calculated based on the filtered data set. For example, the calculated distribution can provide informative context for the enterprise deployment scenario (e.g., job position at the enterprise). In some embodiments, the distribution can be displayed along with the predicted parameters (e.g., parameters for a job offer, such as compensation). Embodiments display this information to a user, thus providing a deployment scenario with a predicted likelihood of success while also providing context based on current and/or historic deployment scenarios (e.g., for similar resources).

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

We claim:

1. A method for generating resource deployment predictions using an ensemble machine learning model, the method comprising:
providing an ensemble machine learning model trained or configured by an aggregated data set, wherein the aggregated data set comprises data about resources deployed in enterprise deployment scenarios aggregated from a plurality of enterprise sources;
receiving data about a first resource including natural language data and numeric score data;
determining a matching score between the first resource and a first enterprise deployment scenario based on at least a matching between natural language data descriptive of the first resource and natural language data descriptive of the first enterprise deployment scenario; and
predicting resource deployment parameters using the ensemble machine learning model based on the determined matching score and the received numeric score data about the first resource.

2. The method of claim 1, further comprising:
retrieving a filtered data set from a plurality of enterprise sources based on the first enterprise deployment scenario;
calculating a distribution of the filtered data set; and
displaying the calculated distribution of the filtered data set and the predicted resource deployment parameters generated by the ensemble machine learning model to a user.

3. The method of claim 2, wherein the first enterprise deployment scenario comprises a job position at the enterprise and the filtered data set comprises data about the job position across a plurality of enterprise divisions.

4. The method of claim 3, wherein matching the natural language data descriptive of the first resource and the natural language data descriptive of the first enterprise deployment scenario comprises generating context based embeddings and calculating a distance between embeddings for the natural language data descriptive of the first resource and embeddings for the natural language data descriptive of the first enterprise deployment scenario.

5. The method of claim 4, wherein the ensemble machine learning model comprises a regression model and a natural language processing model that determines a numeric matching score based on contextual embeddings, wherein the output of the natural language processing model is fed into the regression model.

6. The method of claim 5, wherein input for the regression model comprises the numeric matching score from the natural language processing model and the numeric score data received about the first resource, and the predicted resource deployment parameters comprise a compensation range for the first resource in the first enterprise deployment scenario with a predicted probability of success that meets a criteria.

7. The method of claim 3, wherein the plurality of enterprise sources comprise enterprise divisions, and the filtered data set is retrieved from at least two enterprise divisions that include different sets of data access restrictions.

8. The method of claim 7, wherein the filtered data set is retrieved from the plurality of sources using a set of filters based on the job position.

9. The method of claim 8, further comprising:
determining whether the filtered data set meets a confidentiality criteria;
when the filtered data set fails to meet the confidentiality criteria, broadening one of more of the filters used to retrieve the filtered data set; and
retrieving filtered data using the broadened one or more filters to generate a broadened filtered data set, wherein the broadened filtered data set is larger than the filtered data set, and the calculated distribution that is displayed to a user is calculated based on the broadened filtered data set.

10. The method of claim 9, wherein the calculated distribution that is displayed to a user is calculated based on the broadened filtered data set when the broadened filtered data set meets the confidentiality criteria and a difference between distributions for the broadened filtered data set and the filtered data set meets a similarity criteria.

11. A system for generating resource deployment predictions using an ensemble machine learning model, the system comprising:
a processor and memory storing instructions, wherein, when executing the instructions, the processor is configured to:
provide an ensemble machine learning model trained or configured by an aggregated data set, wherein the aggregated data set comprises data about resources deployed in enterprise deployment scenarios aggregated from a plurality of enterprise sources;
receive data about a first resource including natural language data and numeric score data;
determine a matching score between the first resource and a first enterprise deployment scenario based on at least a matching between natural language data descriptive of the first resource and natural language data descriptive of the first enterprise deployment scenario; and
predict resource deployment parameters using the ensemble machine learning model based on the determined matching score and the received numeric score data about the first resource.

12. The system of claim 11, wherein the processor is configured to:
retrieve a filtered data set from a plurality of enterprise sources based on the first enterprise deployment scenario;
calculate a distribution of the filtered data set; and
display the calculated distribution of the filtered data set and the predicted resource deployment parameters generated by the ensemble machine learning model to a user.

13. The system of claim 12, wherein the first enterprise deployment scenario comprises a job position at the enterprise and the filtered data set comprises data about the job position across a plurality of enterprise divisions.

14. The system of claim 13, wherein matching the natural language data descriptive of the first resource and the natural language data descriptive of the first enterprise deployment scenario comprises generating context based embeddings and calculating a distance between embeddings for the natural language data descriptive of the first resource and embeddings for the natural language data descriptive of the first enterprise deployment scenario.

15. The system of claim 14, wherein the ensemble machine learning model comprises a regression model and a natural language processing model that determines a numeric matching score based on contextual embeddings, wherein the output of the natural language processing model is fed into the regression model.

16. The system of claim 15, wherein input for the regression model comprises the numeric matching score from the natural language processing model and the numeric score data received about the first resource, and the predicted resource deployment parameters comprise a compensation range for the first resource in the first enterprise deployment scenario with a predicted probability of success that meets a criteria.

17. The system of claim 13, wherein the plurality of enterprise sources comprise enterprise divisions, the filtered data set is retrieved from at least two enterprise divisions that include different sets of data access restrictions, and the filtered data set is retrieved from the plurality of sources using a set of filters based on the job position.

18. The system of claim 17, wherein the processor is configured to:
determine whether the filtered data set meets a confidentiality criteria;
when the filtered data set fails to meet the confidentiality criteria, broaden one of more of the filters used to retrieve the filtered data set; and
retrieve filtered data using the broadened one or more filters to generate a broadened filtered data set, wherein the broadened filtered data set is larger than the filtered data set, and the calculated distribution that is displayed to a user is calculated based on the broadened filtered data set.

19. The system of claim 18, wherein the calculated distribution that is displayed to a user is calculated based on the broadened filtered data set when the broadened filtered data set meets the confidentiality criteria and a difference between distributions for the broadened filtered data set and the filtered data set meets a similarity criteria.

20. A non-transitory computer readable medium having instructions stored thereon that, when executed by a processor, cause the processor to generate resource deployment predictions using an ensemble machine learning model, wherein, when executed, the instructions cause the processor to:
providing an ensemble machine learning model trained or configured by an aggregated data set, wherein the aggregated data set comprises data about resources deployed in enterprise deployment scenarios aggregated from a plurality of enterprise sources;
receiving data about a first resource including natural language data and numeric score data;
determining a matching score between the first resource and a first enterprise deployment scenario based on at least a matching between natural language data descriptive of the first resource and natural language data descriptive of the first enterprise deployment scenario; and
predicting resource deployment parameters using the ensemble machine learning model based on the determined matching score and the received numeric score data about the first resource.
